(19) United States
(12) Patent Application Publication
(10) Pub. No.: US 2026/0292887 A1
(43) Pub. Date: Sep. 24, 2026

(54) METHOD FOR CONFIGURED GRANT BASED SMALL DATA TRANSMISSION

(71) Applicant: Continental Automotive Technologies GmbH, Hannover (DE)

(72) Inventors: David GONZALEZ GONZALEZ, Egelsbach, Hessen (DE); Rikin SHAH, Langen, Hessen (DE); Reuben GEORGE STEPHEN, Singapore (SG); Andreas ANDRAE, Frankfurt am Main (DE); Osvaldo GONSA, Frankfurt (DE); Hojin KIM, Regensburg (DE)

(73) Assignee: Continental Automotive Technologies GmbH, Hannover (DE)

(21) Appl. No.: 19/472,500

(22) PCT Filed: Apr. 3, 2024
(86) PCT No.: PCT/EP2024/059087

§ 371 Date: Oct. 3, 2025

(30) Foreign Application Priority Data
Apr. 4, 2023 (DE) 10 2023 203 128.0
Apr. 4, 2023 (DE) 10 2023 203 129.9

(51) Int. Cl. H04W 74/0833; H04W 68/00; H04W 72/1263

(52) U.S. Cl. CPC H04W 74/0833; H04W 68/005; H04W 72/1263

(57) ABSTRACT

A method for mobile-terminated small data transmission, MT-SDT, wherein a timer is established to control when to use configured grant SDT, CG-SDT, resources and when to use random-access SDT, RA-SDT, resources. A user equipment starts the timer when it receives a MT-SDT paging message from a base station and if CG-SDT resources arrive when the timer is running, the UE will transmit a response to the MT-SDT paging message over CG-SDT resources and if CG-SDT resources are not arrived when the timer is running, the UE will use RA-SDT resources to transmit the response.

### CROSS-REFERENCE TO RELATED APPLICATIONS

This application is the U.S. National Phase Application of PCT International Application No. PCT/EP2024/059087, filed Apr. 3, 2024, which claims priority to German Patent Application No. 10 2023 203 128.0, filed Apr. 4, 2023, and to German Patent Application No. 10 2023 203 129.9, filed Apr. 4, 2023, the contents of such applications being incorporated by reference herein.

### TECHNICAL FIELD

The present disclosure relates to wireless communication systems and relates more specifically to methods and devices for mobile-terminated small data transmission, MT-SDT.

### BACKGROUND OF THE INVENTION

Small data transmission (SDT) is a procedure which allows data and/or signaling transmission for a user equipment (UE), while the UE remains in a radio resource control (RRC) inactive state without transitioning to an RRC connected state. Mobile terminated (MT) SDT corresponds to the downlink (DL) SDT, for transmitting small data to the UE.

MT-SDT can be triggered by a network entity such as a gNB, and the UE needs to respond to such an MT-SDT trigger. In some cases, different resources may coexist for responding to such an MT-SDT trigger. For example, the UE may have both configured grant SDT (CG-SDT) resources and random-access SDT (RA-SDT) resources available and the choice of either one or the other may impact the performance of the MT-SDT, e.g., in terms of latency.

### SUMMARY OF THE INVENTION

The present disclosure aims at improving the situation. In particular, the present disclosure aims at addressing at least some of the limitations of the prior art discussed above. In particular, the present disclosure aims at proposing a solution for enhancing MT-SDT procedures, in particular the usage of CG-SDT resources or RA-SDT resources to better control the latency of MT-SDT.

For that purpose, it is proposed that a timer is used to control when the UE uses the CG-SDT resources and when the UE uses the RA-SDT resource, to transmit a response in MT-SDT.

According to a first aspect, the present disclosure relates to a method for mobile-terminated small data transmission, MT-SDT, the method being implemented by a user equipment, UE, wherein configured grant SDT, CG-SDT, resources and random-access SDT, RA-SDT, resources are available for the UE, wherein the method comprises:
receiving a MT-SDT paging message from a base station, BS,
in response to CG-SDT resources occurring before the timer expires, with the timer started when receiving the MT-SDT paging message: using CG-SDT resources for transmitting a response to the BS,
in response to CG-SDT resources not occurring before the timer expires, with the timer started when receiving the MT-SDT paging message: using RA-SDT resources for transmitting the response to the BS.

Hence, the timer is used as a maximum duration allowed for waiting for a CG-SDT occasion and CG-SDT resources are used to transmit the response if a CG-SDT occasion is set to occur within the timer. Otherwise, RA-SDT resources are used. In other words, the CG-SDT resources are used by default if using the CG-SDT resources enables to respond while the timer is running. In cases where the periodicity of the CG-SDT resources is too long, the timer enables to reduce latency by using the RA-SDT resource instead.

In some embodiments, the method according to the first aspect can further comprise one or more of the following optional features, considered either alone or in any technically possible combination.

In some embodiments of the method according to the first aspect, the timer value is configured by the BS.

In some embodiments of the method according to the first aspect, the timer value is configured through system information or through dedicated radio resource control, RRC, signaling.

In some embodiments of the method according to the first aspect, the dedicated RRC signaling is an RRC reconfiguration message or an RRC release message.

In some embodiments of the method according to the first aspect, the MT-SDT paging message includes a quality of service, QoS, indication, and the method comprises determining the timer value to be used based on the QoS indication.

In some embodiments of the method according to the first aspect, the timer value is determined based on a mapping between a plurality of QoS indexes and respective timer values.

In some embodiments of the method according to the first aspect, the mapping between a plurality of QoS indexes and respective timer values is configured through system information or radio resource control, RRC, signaling.

In some embodiments of the method according to the first aspect, the UE is configured with a plurality of different mappings, each mapping being between a plurality of QoS indexes and respective timer values, and the mapping to be used is indicated by the BS.

In some embodiments of the method according to the first aspect, the mapping to be used is indicated through system information or RRC signaling.

According to a second aspect, the present disclosure relates to a user equipment, UE, comprising a wireless transceiver, a processor coupled with a memory in which computer program instructions are stored, said instructions being configured to implement a method according to any one of the embodiments of the first aspect.

According to a third aspect, the present disclosure relates to a method for mobile-terminated small data transmission, MT-SDT, the method being implemented by a BS, wherein the method comprises configuring a value of a timer to be used by a user equipment, UE, to control when to use configured grant SDT, CG-SDT, resources or random-access SDT, RA-SDT, resources for transmitting a response to an MT-SDT paging message transmitted by the BS to the UE.

In some embodiments, the method according to the third aspect can further comprise one or more of the following optional features, considered either alone or in any technically possible combination.

In some embodiments of the method according to the third aspect, the timer value is configured through system information or through dedicated radio resource control, RRC, signaling.

In some embodiments of the method according to the third aspect, the dedicated RRC signaling is an RRC reconfiguration message or an RRC release message.

In some embodiments of the method according to the third aspect, the transmitted MT-SDT paging message includes a quality of service, QoS, indication.

In some embodiments, the method according to the third aspect comprises configuring at the UE at least one mapping between a plurality of QoS indexes and respective timer values.

In some embodiments of the method according to the third aspect, the at least one mapping between a plurality of QoS indexes and respective timer values is configured through system information or radio resource control, RRC, signaling.

In some embodiments of the method according to the third aspect, the UE being configured with a plurality of different mappings, each mapping being between a plurality of QoS indexes and respective timer values, the mapping to be used is indicated by the BS.

In some embodiments of the method according to the third aspect, the BS determines the timer value based on the latency of MT-SDT data.

In some embodiments of the method according to the third aspect, the BS configures a shorter timer value for delay sensitive service.

In some embodiments of the method according to the third aspect, the BS can indicate in the MT-SDT paging message whether to use the CG-SDT resources or RA-SDT resources to transmit the response.

According to a fourth aspect, the present disclosure relates to a base station, for example a gNB, comprising a wireless transceiver, a processor coupled with a memory in which computer program instructions are stored, said instructions being configured to implement a method according to any one of the embodiments of the third aspect.

According to a fifth aspect, the present disclosure relates to a wireless communication system comprising a base station, for example a gNB, according to any one of the embodiments of the present disclosure and a user equipment, UE, according to any one of the embodiments of the present disclosure.

### BRIEF DESCRIPTION OF THE DRAWINGS

Aspects of the invention will be better understood upon reading the following description, given as an example that is in no way limiting, and made in reference to the figures which show:

FIG. 1 is a schematic representation of an example of a user equipment, UE,

FIG. 2: a schematic representation of an example of a BS,

FIG. 3 shows an example in which CG and RA occasions are both available for the UE for MT-SDT,

FIG. 4 shows an example in which CG-SDT resources are not arrived when the timer is running,

FIG. 5 shows an example in which CG-SDT resources are arrived when the timer is running,

FIG. 6 shows an exemplary flow proceeded by a gNB,

FIG. 7 shows an exemplary flow proceeded by a UE,

FIG. 8 shows another exemplary flow proceeded by a gNB,

FIG. 9 shows another exemplary flow proceeded by a UE,

FIG. 10 shows RACH-resource periodicity.

### DETAILED DESCRIPTION OF EXEMPLARY EMBODIMENTS

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc.), Operations & Maintenance (O&M), Operations Support System (OSS), Self-Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

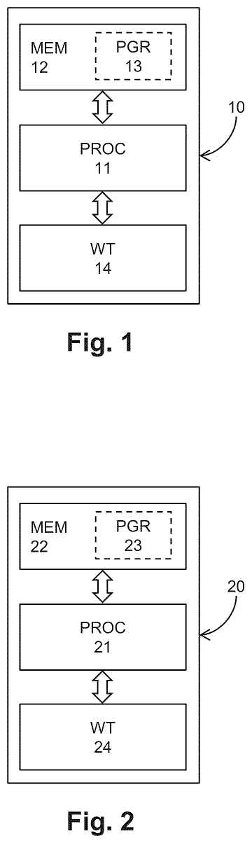

FIG. 1 represents schematically an example of a UE 10 suitable for implementing any method, discussed in the present disclosure, performed at a UE 10. As illustrated by FIG. 1, the UE 10 comprises a processor 11 coupled to a memory 12. The memory 12 may store a computer program product 13, in the form of computer program instructions to be executed by the processor 11 to implement a method for small data transmission, performed at a UE's side, according to any one of the embodiments disclosed herein. As illustrated by FIG. 1, the UE 10 comprises also a wireless transceiver 14 configured to exchange data with a base station, BS, 20. For example, the wireless transceiver 14 is a 5G NR wireless transceiver.

FIG. 2 represents schematically an example of a BS 20 suitable for implementing any method, discussed in the present disclosure, performed at a BS 20. For example, the BS 20 is a gNB. As illustrated by FIG. 2, the BS 20 comprises a processor 21 coupled to a memory 22. The memory 22 may store a computer program product 23, in the form of computer program instructions to be executed by the processor 21 to implement a method for small data transmission, performed at a BS's side, according to any one of the embodiments disclosed herein. As illustrated by FIG. 2, the BS 20 comprises also a wireless transceiver 24 configured to exchange data with UEs. In preferred embodiments, the wireless transceiver 24 is 5G NR wireless transceiver.

As discussed above, the present disclosure describes systems, methods, and apparatuses for MT-SDT. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

As discussed above, SDT is a procedure which allows data and/or signaling transmission while the UE remains in an RRC inactive state without transitioning to an RRC connected state. MT-SDT corresponds to the case of downlink SDT to the UE (whereas mobile originated SDT, MO-SDT, corresponds to the case of uplink SDT).

In some embodiments, a network entity, e.g., a gNB 20, triggers an SDT procedure to transmit downlink data (MT-SDT) to a UE 10 in RRC inactive state. The network entity triggers the uplink (UL) SDT procedure, e.g., as specified in Rel-17, to transmit DL data to the UE 10 in RRC inactive state. In one example, the network entity triggers the UL SDT procedure for the purpose of DL transmission (i.e., the network entity triggers MT-SDT) by means of a downlink SDT triggering message, for example a paging message. The UE 10 initiates the SDT procedure even though there is no uplink data available for transmission in the UE's buffer.

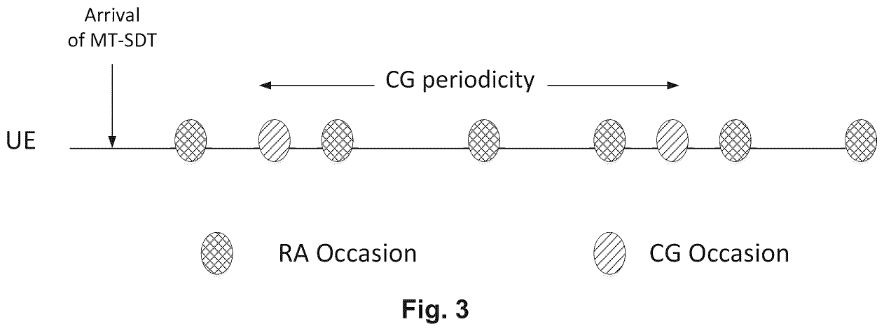

FIG. 3 represents schematically the arrival at the UE 10 of an SDT triggering message (“arrival of MT-SDT” in FIG. 3) transmitted by e.g., a gNB 20. In the example illustrated by FIG. 3, the UE 10 has both CG-SDT resources and RA-SDT resources available for performing the UL SDT for responding to the MT-SDT triggering message. FIG. 3 represents schematically CG occasions (having a CG periodicity) and RA occasions that can be used for performing respectively a CG-SDT or RA-SDT response.

As discussed above, it is proposed that a timer is used to control when the UE 10 uses the CG-SDT resources and when the UE uses the RA-SDT resource, to transmit a response in MT-SDT. For example, the timer being starting when receiving the MT-SDT triggering message (e.g., paging message), the UE 10 may use:
CG-SDT resources for transmitting a response to the gNB 20 if a CG occasion occurs before the timer expires,
RA-SDT resources for transmitting a response to the gNB 20 if a CG occasion does not occur before the timer expires.

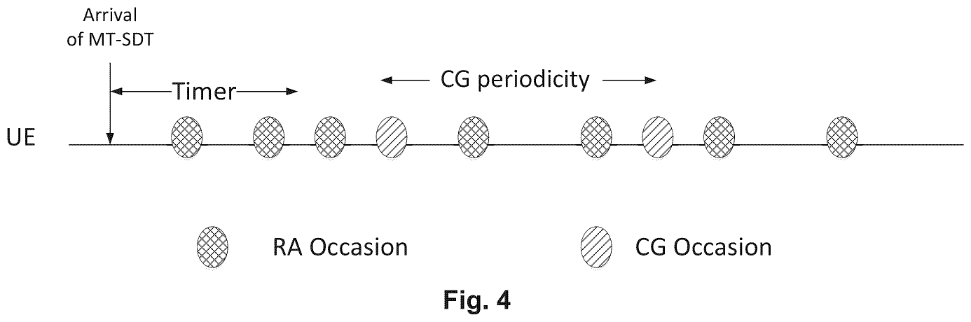

FIG. 4 represents schematically an example in which CG-SDT resources are not arrived when the timer is running (i.e., there is no CG occasion before the timer expires). Accordingly, the UE 10 selects RA-SDT resources to transmit the response.

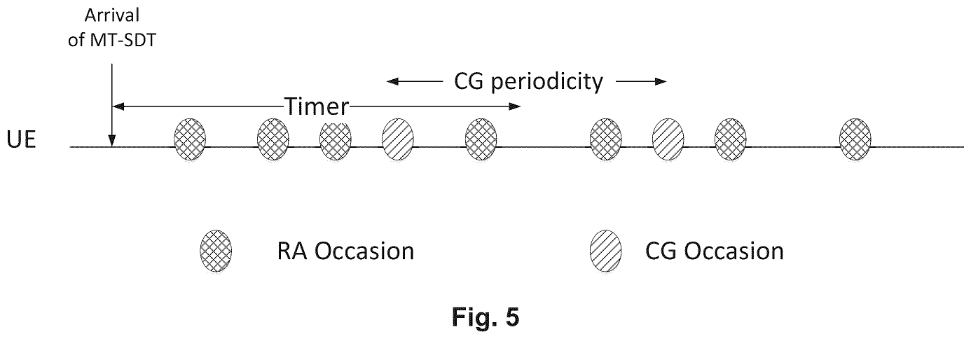

FIG. 5 represents schematically an example in which CG-SDT resources are arrived when the timer is running (i.e., there is a CG occasion before the timer expires). Accordingly, the UE 10 selects CG-SDT resources to transmit the response.

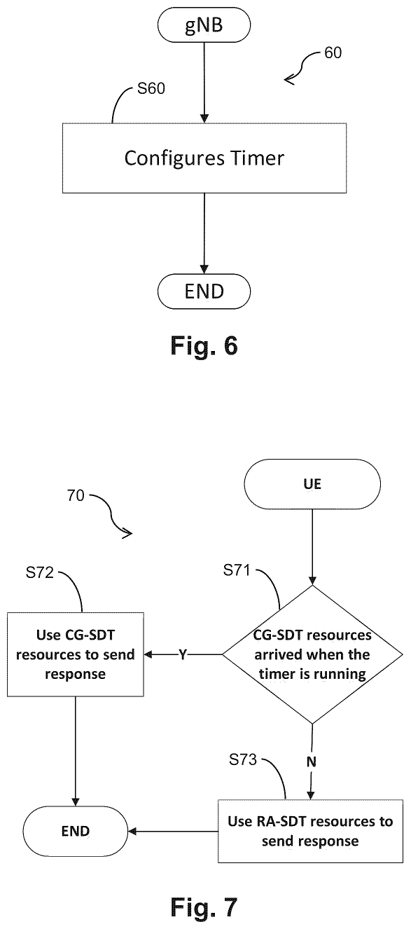

FIG. 6 represents a diagram showing steps of an exemplary embodiment of a method 60 for MT-SDT, which is implemented by a gNB 20.

As illustrated by FIG. 6, the method 60 for MT-SDT comprises a step S60 of configuring the timer (i.e., configuring the timer value) to be used by the UE 10 to control when to use CG-SDT resources or RA-SDT resources in response to an MT-SDT triggering message (e.g., paging message).

For example, the timer value may be configured by the gNB 20 through system information or through dedicated RRC signaling. In the latter case, the dedicated RRC signaling is for example an RRC reconfiguration message or an RRC release message.

In some examples, the gNB 20 may determine the timer value based on e.g. the latency requirement of the MT-SDT data to be transmitted to the UE 10. For example, the gNB 20 may configure a timer value that is shorter for delay sensitive services.

FIG. 7 represents a diagram showing steps of an exemplary embodiment of a method 70 for MT-SDT, which is implemented by a UE 10.

As illustrated by FIG. 7, the method 60 for MT-SDT comprises, after a MT-SDT is triggered, a step S71 of evaluating whether CG-SDT resources arrive when the timer (started when the MT-SDT is received) is running. If CG-SDT resources occur before the timer expires, then the method 70 for MT-SDT comprises a step S72 of using CG-SDT resources for sending the response. In turn, if CG-SDT resources do not occur before the timer expires, then the method 70 for MT-SDT comprises a step S73 of using RA-SDT resources for sending the response.

In some embodiments, the timer value may depend on the QoS (or traffic type) of the MT-SDT. For example, the gNB 20 may include a QoS indication in the MT-SDT triggering message (e.g., paging message) and the UE 10 determines the timer value to be used based on the indicated QoS. For example, the indication of the QoS (or traffic type) can the realized as QoS index. Once the timer value is determined, the UE 10 may control when to use CG-SDT resources or when to use RA-SDT resources to transmit the response to the gNB 20, as described previously.

In some examples, the UE 10 may determine the timer value based on a preconfigured mapping between a plurality of QoS indexes and respective timer values. In some examples, the mapping between the plurality of QoS indexes and the respective timer values is predefined, e.g., defined in the standard specification (hard coded in the UE 10). In other examples, the mapping between the plurality of QoS indexes and the respective timer values is configured by the gNB 20, for example broadcasted as system information or included in RRC signaling (e.g., in an RRC (re) configuration message).

It should be noted that it is also possible, in some cases, to use a plurality of mappings, each mapping being between a plurality of QoS indexes and respective timer values. For example, these mappings can be used by either different cells (and common to all users in that cell) or assigned to different users (different users could use different mappings), for example to prioritize among different user subscriptions. Each mapping may be preconfigured as discussed above (for example predefined in the standard specification, or configured by the gNB 20 through, e.g., system information or RRC signaling). If the UE 10 is configured with a plurality of mappings between a plurality of QoS indexes and respective timer values, the mapping to be used by the UE 10 is for example indicated by the gNB 20. The mapping to be used is for example indicated through, e.g., system information or RRC signaling.

Table 1 and Table 2 represent two examples of mappings between a plurality of QoS indexes and respective timer values.

TABLE 1

| | Timer value (ex. time |
|---|---|
| QoS index | period or number of slots) |
| 1 | X₁ |
| 2 | X₂ |
| 3 | X₃ |
| . . . | . . . |
| N | X_{N} |

TABLE 2

| | Timer value (ex. time |
|---|---|
| QoS index | period or number of slots) |
| 1 | Y₁ |
| 2 | Y₂ |
| 3 | Y₃ |
| . . . | . . . |
| M | Y_{M} |

Hence, by means of the QoS indication, the network can control the timer value to be used for different types of traffic.

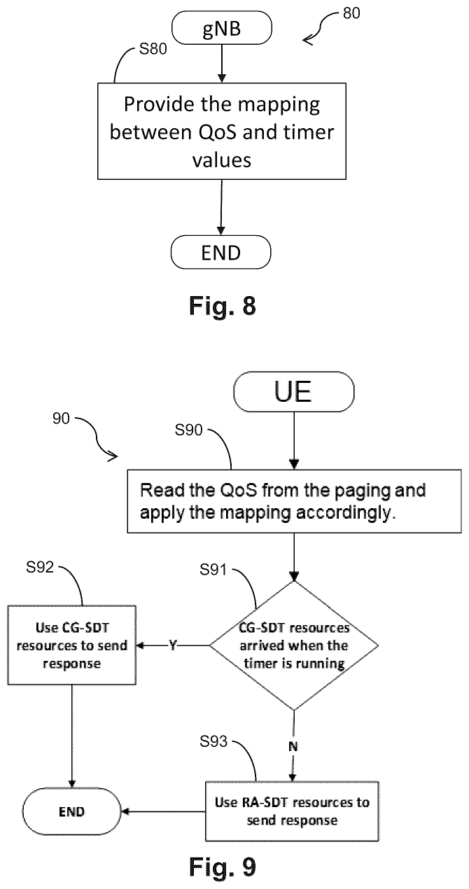

FIG. 8 represents a diagram showing steps of an exemplary embodiment of a method 80 for MT-SDT, which is implemented by a gNB 20.

In the example illustrated by FIG. 8, it is assumed in a non-limitative manner that the gNB 20 configures the mapping(s) between the plurality of QoS indexes and the respective timer values, and the method 80 for MT-SDT comprises a step S80 of configuring at least one mapping between a plurality of QoS indexes and respective timer values. As discussed above, the mapping(s) between a plurality of QoS indexes and respective timer values may be configured through, e.g., system information or RRC signaling.

FIG. 9 represents a diagram showing steps of an exemplary embodiment of a method 90 for MT-SDT, which is implemented by a UE 10.

As illustrated by FIG. 9, the method 90 for MT-SDT comprises a step S90 of receiving a QoS indication in the paging message (which triggers the SDT procedure) which enables the UE 10 to determine the timer value to be used based e.g. on a mapping.

Once the timer value is determined, the behavior of the UE 10 is similar to the behavior described in relation to FIG. 7. As illustrated by FIG. 9, the method 90 for MT-SDT comprises a step S91 of evaluating whether CG-SDT resources arrive when the timer (started when the MT-SDT is received) is running. If CG-SDT resources occur before the timer expires, then the method 90 for MT-SDT comprises a step S92 of using CG-SDT resources for sending the response. In turn, if CG-SDT resources do not occur before the timer expires, then the method 90 for MT-SDT comprises a step S93 of using RA-SDT resources for sending the response.

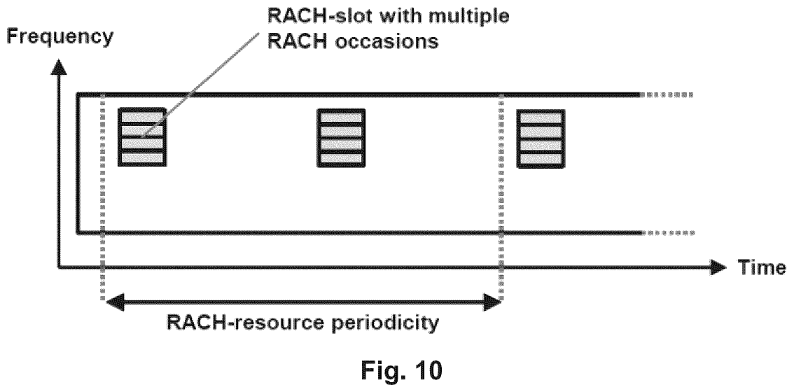

FIG. 10 shows an example of RACH-resource periodicity of a RACH slot and shows that in some cases, a RACH slot may comprise a plurality of RACH occasions (RO). In some examples, it is possible to also indicate the cardinality of the RO to be used by the UE 10 if RA-SDT resources are to be used, the cardinality identifying the RO to be used if multiple ROs are available. For example, the paging message can indicate the cardinality of the RO at each cell/beam to be used by different UEs.

It is emphasized that the present disclosure is not limited to the above exemplary embodiments. Variants of the above exemplary embodiments are also within the scope of the present disclosure.

For example, in some examples, the gNB 20 can indicate in the MT-SDT triggering message (e.g., paging message) whether to use CG-SDT resources or RA-SDT resources to transmit the response. Hence, in such a case, the gNB 20 controls directly which resources the UE 10 shall use. Such a direct control may be considered in combination with the usage of a timer as discussed above (e.g., in some scenarios the gNB 20 may control directly which resources shall be used and, in other scenarios, the UE 10 may control which resources it shall use based on the timer value). In alternate embodiments, it is possible to use only such a direct control of the resources to be used by the gNB 20 (i.e., the gNB 20 explicitly indicates which resources shall be used), without using a timer at the UE.

It should be noted that the following exemplary embodiments are also included in the present disclosure.

Embodiment 1: Method for configured grant based small data transmission, a timer is established to control when to use the CG-SDT resources and when to use the RA-SDT resource, whereby UE starts the timer when it receives Mobile Terminated (MT) small data from gNB and if the CG resources are arrived when the timer is running, the UE will transmit response over CG-SDT resources and if the CG-SDT resources are not arrived when the timer is running, the UE will use the RA-SDT resource to transmit the response.

Embodiment 2: The method according to Embodiment 1, wherein timer value is configured through system information.

Embodiment 3: The method according to any one of Embodiments 1 to 2, wherein timer value is dedicated RRC signaling.

Embodiment 4: The method according to Embodiment 3, wherein the dedicated RRC signaling is RRC reconfiguration message or RRC release message.

Embodiment 5: The method according to any one of Embodiments 1 to 4, wherein gNB can determine timer value based on the latency of MT-SDT data.

Embodiment 6: The method according to any one of Embodiments 1 to 5, for delay sensitive service, gNB configures shorter timer value.

Embodiment 7: The method according to any one of Embodiments 1 to 6, gNB can indicate in the paging message whether to use the CG-SDT resource or RA-SDT resource to transmit response.

Embodiment 8: Apparatus for configured grant based small data transmission, the apparatus comprising a wireless transceiver, a processor coupled with a memory in which computer program instructions are stored, said instructions being configured to implement steps of any one of Embodiments 1 to 7.

Embodiment 9: User Equipment comprising an apparatus according to Embodiment 8.

Embodiment 10: Base station comprising an apparatus according to Embodiment 9.

Embodiment 11: Wireless communication system, wherein the gNB comprises a processor coupled with a memory in which computer program instructions are stored, said instructions being configured to implement steps of any one of Embodiments 1 to 7, and wherein the user equipment (UE) comprises a processor coupled with a memory in which computer program instructions are stored, said instructions being configured to implement steps of any one of Embodiments 1 to 7.

Embodiment 12: Method for QoS specific configured grant based small data transmission, reading the QoS from the paging and apply the mapping accordingly, a timer is configured to control when to use the CG-SDT resources and when to use the RA-SDT resource, whereby UE starts the timer when it receives Mobile Terminated (MT) small data from gNB and if the CG resources are arrived when the timer is running, the UE will transmit response over CG-SDT resources and if the CG-SDT resources are not arrived when the timer is running, the UE will use the RA-SDT resource to transmit the response.

Embodiment 13: The method according to Embodiment 12, wherein timer values are configured through system information by gNB.

Embodiment 14: The method according to any one of Embodiments 12 to 13, wherein gNB provides the mapping between QoS and timer values.

Embodiment 15: The method according to any one of Embodiments 12 to 14, wherein timer value is dedicated RRC signaling.

Embodiment 16: The method according to Embodiment 15, wherein the dedicated RRC signaling is RRC reconfiguration message or RRC release message.

Embodiment 17: The method according to any one of Embodiments 12 to 16, wherein gNB can determine timer value based on the latency of MT-SDT data.

Embodiment 18: The method according to any one of Embodiments 12 to 17, for delay sensitive service, gNB configures shorter timer value.

Embodiment 19: The method according to any one of Embodiments 12 to 18, gNB can indicate in the paging message whether to use the CG-SDT resource or RA-SDT resource to transmit response.

Embodiment 20: Apparatus for QoS specific configured grant based small data transmission, the apparatus comprising a wireless transceiver, a processor coupled with a memory in which computer program instructions are stored, said instructions being configured to implement steps of any one of Embodiments 12 to 19.

Embodiment 21: User Equipment comprising an apparatus according to Embodiment 20.

Embodiment 22: Base station comprising an apparatus according to Embodiment 20.

Embodiment 23: Wireless communication system, wherein the gNB comprises a processor coupled with a memory in which computer program instructions are stored, said instructions being configured to implement steps of any one of Embodiments 12 to 19, and wherein the user equipment (UE) comprises a processor coupled with a memory in which computer program instructions are stored, said instructions being configured to implement steps of any one of Embodiments 12 to 19.

1. A method for mobile-terminated small data transmission, MT-SDT, the method being implemented by a user equipment, UE, wherein configured grant SDT, CG-SDT, resources and random-access SDT, RA-SDT, resources are available for the UE, wherein the method comprises:
receiving a MT-SDT paging message from a base station, BS,
in response to CG-SDT resources occurring before the timer expires, with the timer started when receiving the MT-SDT paging message: using CG-SDT resources for transmitting a response to the BS,
in response to CG-SDT resources not occurring before the timer expires, with the timer started when receiving the MT-SDT paging message: using RA-SDT resources for transmitting the response to the BS.

2. The method according to claim 1, wherein the timer value is configured by the BS.

3. The method according to claim 2, wherein the timer value is configured through system information or through dedicated radio resource control, RRC, signaling.

4. The method according to claim 3, wherein the dedicated RRC signaling is an RRC reconfiguration message or an RRC release message.

5. The method according to claim 1, wherein the MT-SDT paging message includes a quality of service, QoS, indication, and the method comprises determining the timer value to be used based on the QoS indication.

6. The method according to claim 5, wherein the timer value is determined based on a mapping between a plurality of QoS indexes and respective timer values.

7. The method according to claim 6, wherein the mapping between a plurality of QoS indexes and respective timer values is configured through system information or radio resource control, RRC, signaling.

8. The method according to claim 6, wherein the UE is configured with a plurality of different mappings, each mapping being between a plurality of QoS indexes and respective timer values, and the mapping to be used is indicated by the BS.

9. The method according to claim 8, wherein the mapping to be used is indicated through system information or RRC signaling.

10. A user equipment, UE, comprising a wireless transceiver, a processor coupled with a memory in which computer program instructions are stored, said instructions being configured to implement a method according to claim 1.

11. A method for mobile-terminated small data transmission, MT-SDT, the method being implemented by a base station, BS, wherein the method comprises configuring a value of a timer to be used by a user equipment, UE, to control when to use configured grant SDT, CG-SDT, resources or random-access SDT, RA-SDT, resources for transmitting a response to an MT-SDT paging message transmitted by the BS to the UE.

12. The method according to claim 11, wherein the timer value is configured through system information or through dedicated radio resource control, RRC, signaling.

13. The method according to claim 12, wherein the dedicated RRC signaling is an RRC reconfiguration message or an RRC release message.

14. The method according to claim 11, wherein the transmitted MT-SDT paging message includes a quality of service, QoS, indication.

15. The method according to claim 14, comprising configuring at the UE at least one mapping between a plurality of QoS indexes and respective timer values.

16. The method according to claim 15, wherein the at least one mapping between a plurality of QoS indexes and respective timer values is configured through system information or radio resource control, RRC, signaling.

17. The method according to claim 14, wherein, the UE being configured with a plurality of different mappings, each mapping being between a plurality of QoS indexes and respective timer values, the mapping to be used is indicated by the BS.

18. The method according to claim 11, wherein the BS determines the timer value based on the latency of MT-SDT data.

19. The method according to claim 11, wherein the BS configures a shorter timer value for delay sensitive service.

20. The method according to claim 11, wherein the BS can indicate in the MT-SDT paging message whether to use the CG-SDT resources or RA-SDT resources to transmit the response.

21. A base station comprising a wireless transceiver, a processor coupled with a memory in which computer program instructions are stored, said instructions being configured to implement a method according to claim 11.

22. A wireless communication system comprising a base station comprising a wireless transceiver and a processor coupled with a memory in which computer program instruction are stored; and a user equipment, UE, comprising a wireless transceiver and a processor coupled with a memory in which computer program instructions are stored, wherein each set of instructions in the base station in the UE are configured to implement method according to claim 1.
